(19) United States
(12) Patent Application Publication
(10) Pub. No.: US 2013/0113223 A1
(43) Pub. Date: May 9, 2013

(54) CHILDPROOF SAFETY LOCKING SYSTEM

(71) Applicants: Steve Fogarty, Washington, MI (US); Michele Fogarty, Washington, MI (US); Alan Verstraete, Washington, MI (US); Mary Verstraete, Washington, MI (US)

(72) Inventors: Steve Fogarty, Washington, MI (US); Michele Fogarty, Washington, MI (US); Alan Verstraete, Washington, MI (US); Mary Verstraete, Washington, MI (US)

(21) Appl. No.: 13/288,861

(22) Filed: Nov. 3, 2011

(51) Int. Cl. E05C 19/18

(52) U.S. Cl. 292/253

(57) ABSTRACT

A child-proof safety locking system may include an elastomeric loop. The loop may have at least one locking ball attached at a bottom end of the loop so that when the loop is wrapped around an object, a top end of the loop surrounds the locking ball and the top end of the loop is held in position overlying the bottom end of the loop.

### RELATED APPLICATIONS

This application claims the benefit of U.S. Provisional Patent Application No. 6,847,744 filed on Nov. 18, 2010.

### BACKGROUND OF THE INVENTION

The present invention generally relates to locking devices for enhancing child safety. More particularly, the invention relates to “childproof” locking devices for cabinetry and household appliances.

In a typical household there may be many cabinets and appliances such as refrigerators and ovens which have doors and drawers that should be made inaccessible to small children who may be present in the household.

Numerous so-called “childproof” locks and latches are available on the market. Many of these products may require permanent tool-assisted installation on a cabinet. Alternatively, some products may be constructed with complex locking systems for engagement with cabinet latches or knobs.

As can be seen, there is a need for a system of making cabinets and appliances inaccessible to small children without requiring use of complex locking systems or permanent tool-assisted installation of safety devices on cabinets or appliances.

### SUMMARY OF THE INVENTION

In one aspect of the present invention, a child-proof safety locking device may comprise: an elastomeric loop; and at least one locking ball attached to the loop at a bottom end of the loop so that when the loop is wrapped around an object, a top end of the loop surrounds the locking ball and the top end of the loop is held in position overlying the bottom end of the loop.

In another aspect of the present invention, a child-proof safety locking device kit may comprise: an elastomeric loop with locking balls attached to the loop; and an adhesive-backed cabinet attachment hook configured for engagement with the loop.

These and other features, aspects and advantages of the present invention will become better understood with reference to the following drawings, description and claims.

### BRIEF DESCRIPTION OF THE DRAWINGS

FIG. 1 is a perspective view of a safety locking device in accordance with an embodiment of the invention;

FIG. 2 is a plan view of the device of FIG. 1;

FIG. 3 is a top view of the device of FIG. 1 showing an operational feature of the device;

FIG. 4 is a perspective view of the device of FIG. 1 showing an operational feature of the device;

FIG. 5 is a partial sectional view of a cabinet showing an operational feature of the device of FIG. 1;

FIG. 6 is a perspective view of a cabinet showing an operational feature of the device of FIG. 1;

FIG. 7 is a partial sectional view of the cabinet of FIG. 6 showing an operational feature of the device of FIG. 1; and

FIGS. 8 and 9 are perspective views of holding hooks in accordance with the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a self-locking elastomeric loop that may be easily engaged and released from knobs or handles of cabinets and/or appliances by an adult, but which may be difficult to remove by a small child.

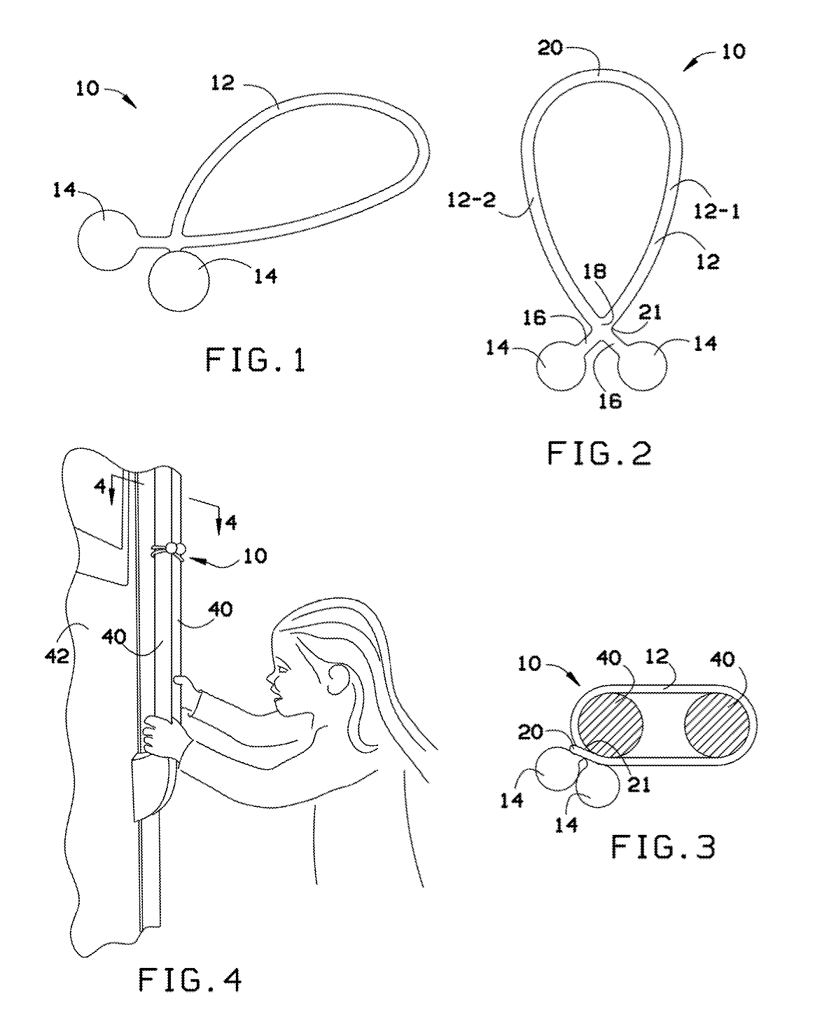

Referring now to FIGS. 1 and 2 it may be seen that an exemplary embodiment of a self-locking device 10 may include a closed loop 12 and one or more locking balls 14 formed outside of the loop 12. The device 10 may be constructed from an elastomeric material such as silicone rubber.

Advantageously the device 10 may be constructed from material that may have regulatory approval for contact by small children. The loop 12 and locking balls 14 may constructed as a single integrally molded device.

The loop 12 may be constructed with a cross-sectional thickness between about 3 mm to about 7 mm. The device 10 may be constructed in various sizes with lengths of the loop 12 ranging from about 60 mm to about 150 mm. Advantageously, the loop 12 may have a teardrop shape. The balls 14 may be spherical and may have a diameter between about 10 mm to about 25 mm. The balls 14 may be positioned at ends of extensions 16 at a distance of about 10 mm to about 20 mm away from a joining point 18 of the loop 12. In an exemplary configuration, a first one of the extensions 16 may project outwardly from the joining point 18 in alignment with a right hand portion 12-1 of the loop 12 and a second one of the extensions 16 may project outwardly from the joining point 18 in alignment with a left hand portion 12-2 of the loop 12.

Referring now to FIGS. 3 and 4, it may be seen that, in an exemplary application, that the device 10 may be placed around two handles 40 of a refrigerator 42. The loop 12 may be stretched and wrapped around the handles so that a top end 20 overlies a bottom end 21 of the loop 12. The top end 20 of the loop 12 may be passed over the locking balls 14 and then allowed to relax into engagement with the extensions 16. In this configuration the device 10 may be considered to be in a locked mode. The locking balls 14 may prevent the device 10 from opening. Thus the refrigerator doors 40 may be held closed by the device 10 in the event that a child attempts to open the refrigerator 42. An adult may easily open the refrigerator 42 by pulling the top end 20 of the loop 12 over the locking balls 14 to release the device 10. The adult may just as easily replace the device 10 on the handles 40 after closing the refrigerator 42.

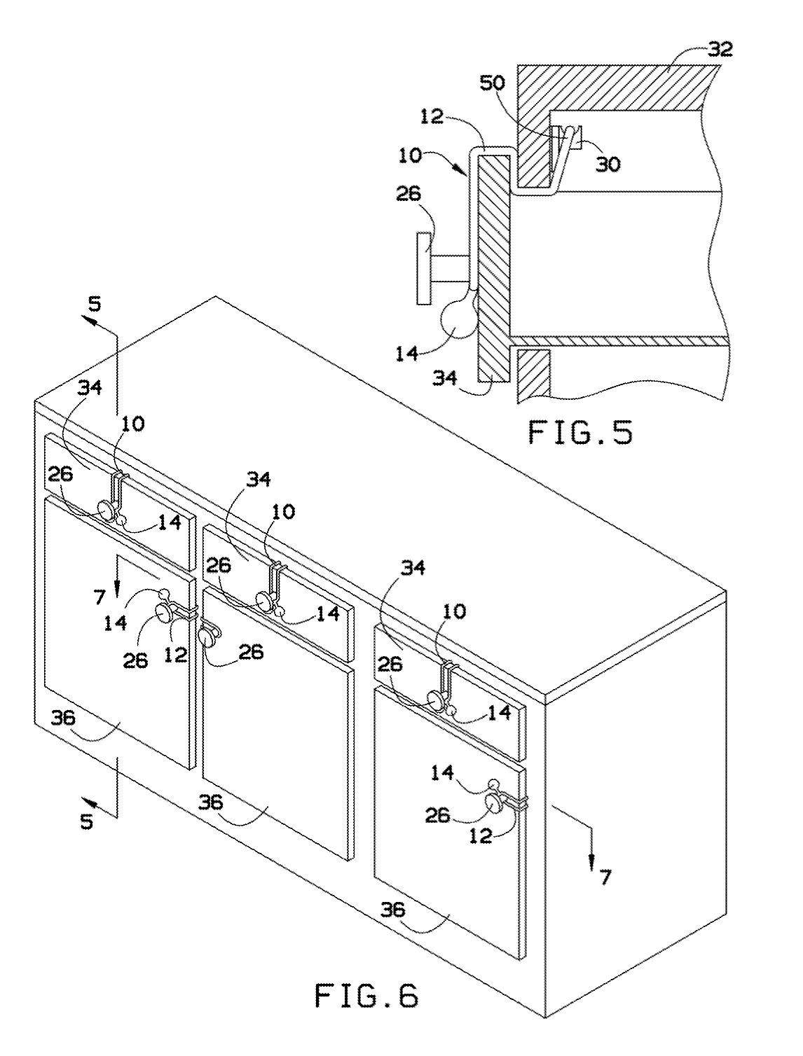

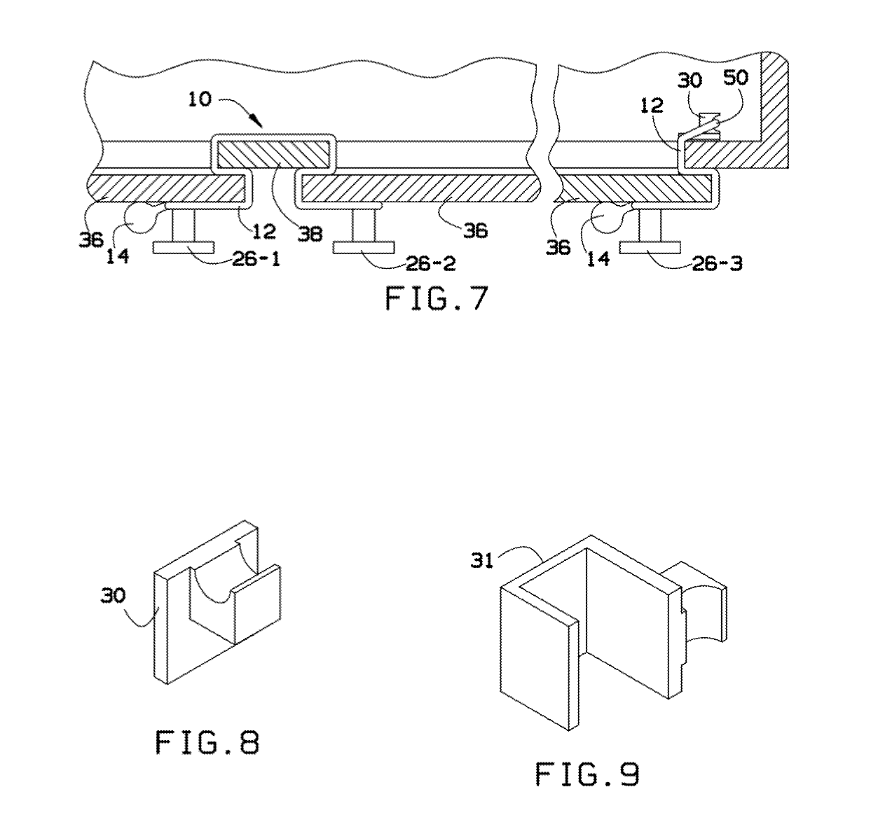

Referring now to FIGS. 5, 6 and 7, it may be seen the device 10 may be employed in various other exemplary applications. As seen in FIGS. 5 and 7, a holding hook 30 may be adhesively secured to an interior surface of a cabinet 32. The device 10 may be placed over the hook 30 and then stretched around a drawer face 34 to engage with a cabinet knob 26. Alternatively, a wrap-around hook 31, as shown in FIG. 9, may be employed to secure the device 10 within the cabinet 32.

It may be seen that the devices 10 may be stretched from a first knob 26-1 to a second knob 26-1 while being passed behind a stile 38 of a cabinet. Alternatively, one the devices 10 may be placed onto one of the hooks 30 and stretched around one of the knobs 26 of a cabinet door 36.

One or more of the devices 10 and one or more of the hooks 30 may be combined and sold as a kit 50. One of the kits 50 may contain a plurality of the devices 10 which may have various lengths ranging from about 6 inches to about 12 inches. With such a kit, a parent of a young child may be able to secure cabinet doors and drawers of various sizes and configurations.

It should be understood, of course, that the foregoing relates to exemplary embodiments of the invention and that modifications may be made without departing from the spirit and scope of the invention as set forth in the following claims.

What is claimed is:

1. A child-proof safety locking device comprising:
a elastomeric loop; and
a least one locking ball attached to the loop at a bottom end of the loop so that when the loop is wrapped around an object, a top end of the loop surrounds the locking ball and the top end of the loop is held in position overlying the bottom end of the loop.

2. The locking device of claim 1 wherein the loop and the at least one locking ball are constructed as a singular integrally molded device.

3. The locking device of claim 2 wherein the loop and the at least one locking ball are silicone rubber.

4. The locking device of claim 1 comprising two of the locking balls.

5. The locking device of claim 1 wherein the loop has a teardrop shape.

6. The locking device of claim 1 further comprising an elastomeric extension attached to the loop and projecting outwardly from the loop, wherein the at least one locking ball is attached to the extension.

7. The locking device of claim 6 comprising:
two of the locking balls; and
two of the extensions,
wherein a first one of the extensions projects outwardly from a joining point of the loop in alignment with a right hand portion of the loop and a second one of the extensions projects outwardly from the joining point in alignment with a left hand portion of the loop.

8. A child-proof safety locking device kit comprising:
a elastomeric loop with locking balls attached to the loop; and
an adhesive-backed cabinet attachment hook configured for engagement with the loop.

9. The locking device kit of claim 8 further comprising a plurality of the loops in sizes ranging from lengths of about 60 mm to about 150 mm.

10. The locking device kit of claim 8 wherein the loop and the locking balls are silicone rubber and are formed as a singular integrally molded device.
